(19) United States
(12) Patent Application Publication
(10) Pub. No.: US 2016/0156261 A1
(43) Pub. Date: Jun. 2, 2016

(54) CONTROL CIRCUIT AND METHOD

(71) Applicant: Semiconductor Components Industries, LLC, Phoenix, AZ (US)

(72) Inventor: Yoshinobu Kaneda, Ora-gun (JP)

(73) Assignee: Semiconductor Components Industries, LLC, Phoenix, AZ (US)

(21) Appl. No.: 14/951,744

(22) Filed: Nov. 25, 2015

Related U.S. Application Data
(60) Provisional application No. 62/085,502, filed on Nov. 29, 2014.

(51) Int. Cl. H02M 3/07; H02M 1/14

(52) U.S. Cl. CPC H02M 3/07; H02M 1/14

(57) ABSTRACT

In accordance with an embodiment, a control circuit includes a multifunction current analysis circuit configured to receive a first current and connected to a charge pump circuit. An output of a charge pump is connected to an input of the multifunction current analysis circuit, and an oscillator control circuit has an input connected to an output of the multifunction current analysis circuit and to an input of the charge pump through an oscillator circuit. In accordance with another embodiment, a method for controlling a voltage of a semiconductor component is provided that includes generating a first current, a second current, and a third current from a charge pump output circuit and comparing the second current level with the third current level to generate a first comparison result. The first comparison result is used to control a frequency of an output signal of an oscillator circuit.

### BACKGROUND

The present invention relates, in general, to electronics and, more particularly, to control circuits and methods.

In the past, the semiconductor industry used various methods and structures to form charge pump converter circuits. These charge pump converter circuits generally were used to receive a voltage from an energy source, such as a battery, and create various output voltages that were ratioed to the value of the input voltage. With the implementation of energy conservation specifications such as Energy-Star, it has become important for charge pump converters to more efficiently use the energy from the energy source. In some implementations, the charge pump converter was configured to have negative feedback to control the frequency of a booster circuit which helped reduce power consumption of the charge pump circuit. A drawback with charge pump converters configured with negative feedback is that ripple occurs in the output signal that increases power consumption and reduces the accuracy of the regulated voltage.

Accordingly, it is desirable to have a charge pump converter that has high efficiency while reducing the ripple that appears in the regulated output voltage. In addition, it is desirable for the circuit and method to be cost and time efficient to implement.

### BRIEF DESCRIPTION OF THE DRAWINGS

The present invention will be better understood from a reading of the following detailed description, taken in conjunction with the accompanying drawing figures, in which like reference characters designate like elements and in which:

FIG. 1 is a schematic diagram of a control circuit configured for controlling a charge pump circuit in accordance with an embodiment of the present invention;

FIG. 2 is a schematic diagram of a control circuit configured for controlling a charge pump circuit in accordance with another embodiment of the present invention;

FIG. 3 is a schematic diagram of a portion of the control circuit of FIG. 1 and FIG. 2; and

FIG. 4 is a flow diagram illustrating a method for controlling a charge pump in accordance with another embodiment of the present invention.

For simplicity and clarity of illustration, elements in the figures are not necessarily to scale, and the same reference characters in different figures denote the same elements. Additionally, descriptions and details of well-known steps and elements are omitted for simplicity of the description. As used herein current carrying electrode means an element of a device that carries current through the device such as a source or a drain of an MOS transistor or an emitter or a collector of a bipolar transistor or a cathode or an anode of a diode, and a control electrode means an element of the device that controls current flow through the device such as a gate of an MOS transistor or a base of a bipolar transistor. Although the devices are explained herein as certain n-channel or p-channel devices, or certain n-type or p-type doped regions, a person of ordinary skill in the art will appreciate that complementary devices are also possible in accordance with embodiments of the present invention. It will be appreciated by those skilled in the art that the words during, while, and when as used herein are not exact terms that mean an action takes place instantly upon an initiating action but that there may be some small but reasonable delay, such as a propagation delay, between the reaction that is initiated by the initial action and the initial action. The use of the words approximately, about, or substantially means that a value of an element has a parameter that is expected to be very close to a stated value or position. However, as is well known in the art there are always minor variances that prevent the values or positions from being exactly as stated. It is well established in the art that variances of up to about ten per cent (10%) (and up to twenty per cent (20%) for semiconductor doping concentrations) are regarded as reasonable variances from the ideal goal of being exactly as described.

It should be noted that a logic zero voltage level (V_{L}) is also referred to as a logic low voltage or logic low voltage level and that the voltage level of a logic zero voltage is a function of the power supply voltage and the type of logic family. For example, in a Complementary Metal Oxide Semiconductor (CMOS) logic family a logic zero voltage may be thirty percent of the power supply voltage level. In a five volt Transistor-Transistor Logic (TTL) system a logic zero voltage level may be about 0.8 volts, whereas for a five volt CMOS system, the logic zero voltage level may be about 1.5 volts. A logic one voltage level (V_{H}) is also referred to as a logic high voltage level, a logic high voltage, or a logic one voltage and, like the logic zero voltage level, the logic high voltage level also may be a function of the power supply and the type of logic family. For example, in a CMOS system a logic one voltage may be about seventy percent of the power supply voltage level. In a five volt TTL system a logic one voltage may be about 2.4 volts, whereas for a five volt CMOS system, the logic one voltage may be about 3.5 volts.

### DETAILED DESCRIPTION

Generally, the present invention provides a method for controlling an internal voltage supplied to a semiconductor device and a control circuit configured to control the internal voltage. In accordance with an embodiment, the control circuit comprises a charge pump having an output connected to a current determination/comparator circuit, and a regulator circuit connected to an output of the current determination/comparator circuit.

In accordance with an aspect, the control circuit further includes an oscillator circuit having an input and an output, wherein the input is connected to an input of the charge pump.

In accordance with another aspect, the control circuit further includes an oscillator control circuit having a first input and an output, wherein the output of the oscillator control circuit is connected to an input of the oscillator circuit.

In accordance with another aspect, the oscillator control circuit further includes a second input and the current determination/comparator circuit further includes a second output and a third output, wherein the second output of the current determination/comparator circuit is coupled to the first output of the oscillator control circuit and the third output of the current determination/comparator circuit is coupled to the second input of the oscillator control circuit.

In accordance with another aspect, the oscillator control circuit further includes a second input and the current determination/comparator circuit further includes a second output and a third output, and further including a sampling circuit having a first input, a second input, a first output, and a second output, wherein the second output of the current determination/comparator circuit is coupled to the first input of the sampling circuit, the third output of the current determination/comparator circuit is coupled to the second input of the sampling circuit, the first output of the sampling circuit is coupled to the first input of the oscillator control circuit and the second output of the sampling circuit is coupled to the second input of the oscillator control circuit.

In accordance with another aspect, the current determination/comparator circuit comprises: a current mirror having a first terminal, a second terminal, and a third terminal; a first current source coupled to the first terminal of the current minor; a first voltage level shifting circuit having a first terminal and a second terminal, the first terminal of the first voltage level shifting circuit coupled to the second terminal of the current mirror; a second voltage level shifting circuit having a first terminal and a second terminal, the first terminal of the second voltage level shifting circuit coupled to the third terminal of the current minor, the second terminal of the second voltage level shifting circuit coupled to the second terminal of the first voltage level shifting circuit; and a second current source having a first terminal and a second terminal, the first terminal of the second current source coupled to the second terminal of the first voltage level shifting circuit and the second terminal of the second voltage level shifting circuit.

In accordance with another aspect, the current mirror comprises a first current source having a first terminal and a second terminal; a first transistor having a control electrode, a first current carrying electrode, and a second current carrying electrode, wherein the control electrode of the first transistor is coupled to the first current carrying electrode of the first transistor and to the first terminal of the first current source, and the second current carrying electrode is coupled for receiving a first source of operating potential; a second transistor having a control electrode, a first current carrying electrode, and a second current carrying electrode, wherein the control electrode of the second transistor is coupled to the control electrode of the first transistor, the first current carrying electrode of the second transistor serves as the second terminal of the current minor, and the second current carrying electrode is coupled for receiving the first source of operating potential; and a third transistor having a control electrode, a first current carrying electrode, and a second current carrying electrode, wherein the control electrode of the third transistor is coupled to the control electrodes of the first transistor, the first current carrying electrode of the third transistor serves as the third terminal of the current minor, and the second transistor and the second current carrying electrode is coupled for receiving the first source of operating potential.

In accordance with another aspect, the first voltage level shifting circuit comprises: a fourth transistor having a control electrode, a first current carrying electrode, and a second current carrying electrode, the control electrode of the fourth transistor coupled to the first current carrying electrode of the fourth transistor, and the second current carrying electrode of the fourth transistor coupled to the first current carrying electrode of the second transistor; a fifth transistor having a control electrode, a first current carrying electrode, and a second current carrying electrode, the control electrode of the fifth transistor coupled to the first current carrying electrode of the fifth transistor and the second current carrying electrode of the fifth transistor coupled to the first current carrying electrode of the fourth transistor; and a sixth transistor having a control electrode, a first current carrying electrode, and the second current carrying electrode, the second current carrying electrode of the sixth transistor coupled to the first current carrying electrode of the fifth transistor.

In accordance with another aspect, the second voltage level shifting circuit comprises: a seventh transistor having a control electrode, a first current carrying electrode, and a second current carrying electrode, the control electrode of the seventh transistor coupled to the first current carrying electrode of the seventh transistor, and the second current carrying electrode of the seventh transistor coupled to the first current carrying electrode of the third transistor; an eighth transistor having a control electrode, a first current carrying electrode, and a second current carrying electrode, the control electrode of the eighth transistor coupled to the first current carrying electrode of the seventh transistor and the second current carrying electrode of the eighth transistor coupled to the first current carrying electrode of the seventh transistor; and a ninth transistor having a control electrode, a first current carrying electrode, and the second current carrying electrode, the control electrode of the ninth transistor coupled to the control electrode of the sixth transistor and the second current carrying electrode of the ninth transistor coupled to the first current carrying electrode of the eighth transistor.

In accordance with another aspect, the current determination/comparator circuit further includes a tenth transistor having a control electrode, a second current carrying electrode, and a third current carrying electrode, the control electrode of the tenth transistor coupled to the control electrode of the sixth transistor and to the control electrode of the ninth transistor, and the first current carrying electrode of the tenth transistor coupled to the first current carrying electrode of the sixth transistor and to the first current carrying electrode of the ninth transistor.

In accordance with another aspect, the control circuit further includes a Zener diode having an anode and a cathode, the cathode of the Zener diode coupled to the second current carrying electrode of the tenth transistor and the anode of the Zener diode coupled for receiving the first source of operating potential.

In accordance with another embodiment, the control circuit is provided that comprises a multifunction current analysis circuit having an input and a first output and a second output, the input of the multifunction current analysis circuit configured to receive a first current; an oscillator control circuit having a first input, a second input, and an output, the first input of the oscillator control circuit coupled to the first output of the multifunction current analysis circuit and the second input of the oscillator control circuit coupled to the second output of the multifunction current analysis circuit; and a charge pump circuit having an input and an output, the input of the charge pump circuit coupled to the output of the oscillator control circuit.

In accordance with an aspect, the regulator circuit has an input and an output, wherein the input is coupled to a third output of the multifunction current analysis circuit.

In accordance with another aspect, the control circuit further includes a regulator circuit having an input and an output, the input of the regulator circuit coupled to a third output of the multifunction current analysis circuit.

In accordance with another aspect, the control circuit further includes a sampling circuit having a first input, a second input, a first output, and a second output, wherein the first input of the sampling circuit is coupled to the first output of the multifunction current analysis circuit, the second input of the sampling circuit is coupled to the second output of the multifunction current analysis circuit, the first output of the sampling circuit is coupled to the first input of the oscillator control circuit, and the second output of the sampling circuit is coupled to the second input of the oscillator control circuit.

In accordance with another aspect, the control circuit further includes a regulator circuit having an input and an output, the input of the regulator circuit coupled to a third output of the multifunction current analysis circuit.

In accordance with another aspect, the multifunction analysis circuit comprises the multifunction current analysis circuit comprises: a current minor having a first terminal, a second terminal, and a third terminal; a first current source coupled to the first terminal of the current minor; a first voltage level shifting circuit having a first terminal and a second terminal, the first terminal of the first voltage level shifting circuit coupled to the second terminal of the current minor; a second voltage level shifting circuit having a first terminal and a second terminal, the first terminal of the second voltage level shifting circuit coupled to the third terminal of the current minor, the second terminal of the second voltage level shifting circuit coupled to the second terminal of the first voltage level shifting circuit; and a second current source having a first terminal and a second terminal, the first terminal of the second current source coupled to the second terminal of the first voltage level shifting circuit and the second terminal of the second voltage level shifting circuit.

In accordance with another embodiment, a method for controlling a voltage of a semiconductor component is provided, wherein the method comprises using a charge pump circuit to generate a charge pump current, wherein the charge pump current comprises at least a first portion and a second portion; generating a first current having a first current level from the first portion of the charge pump current, a second current having a second current level from the first portion of the charge pump circuit, and a third current having a third current level from the first portion of the charge pump current, wherein the second current level and the third current level are less than the first current level; comparing the second current level with the third current level to generate a first comparison result; and using the first comparison result to control a frequency of an output signal of an oscillator circuit.

In accordance with another aspect, generating the first current having the first current level from the first portion of the charge pump current, the second current having the second current level from the first portion of the charge pump circuit, and the third current having the third current level from the first portion of the charge pump current comprises: generating the first current using a regulator circuit; and generating the second current and the third current using a current mirror, wherein the third current level is n times the second current level, and wherein n is an integer.

In accordance with another aspect, the method further includes increasing a frequency of an oscillator output signal in response to the first current level of the first current being less than the second current level of the second current and increasing the frequency of the oscillator output signal in response to the first current level of the first current being greater than the third current level of the third current.

In accordance with another aspect, the method further includes leaving frequency of the oscillator circuit unchanged in response to the first current level of the first current being greater than the second current level of the second current or less than the third current level of the third current.

FIG. 1 is a block diagram of a control circuit 10 configured for determining a current and for comparing the current with a reference current in accordance with an embodiment of the present invention. Control circuit 10 includes a charge pump circuit 12, a current determination/comparator circuit 14, a sampling circuit 16, an oscillator control circuit 18, and an oscillator circuit 20 and may be referred to as a booster circuit system. Current determination/comparator circuit 14 may be referred to as a current measurement/comparison circuit and is configured to measure excess current within the system. Charge pump circuit 12 has an input 12A and an output 12B, wherein output 12B of charge pump circuit 12 is connected to an input 14A of current determination/comparator circuit 14 and to a load 22. It should be noted that charge pump circuit 12 may be referred to as a charge pump, whereas circuit 14 may be referred to as a current determination/comparator circuit because it is configured to determine a current level of the current flowing through regulator circuit 24 and to compare the current flowing through regulator circuit 24 with a reference current and output a plurality of logic values in response to the comparison. Current determination/comparator circuit 14 includes an output 14B connected to a voltage regulator 24, which may be, for example, a diode, an output 14C, and an output 14D, where outputs 14C and 14D are connected to sampling circuit 16. In accordance with an embodiment, sampling circuit 16 may have an input 16A connected to output 14C of current determination/comparator circuit 14, an input 16B connected to output 14D of current determination/comparator circuit 14, an output 16C connected to an input 18A of oscillator control circuit 18, and an output 16D connected to an input 18B of oscillator control circuit 18. Oscillator circuit 20 has an input 20A connected to an output 18C of oscillator control circuit 18 and an output 20B connected to input 12A of charge pump circuit 12.

In operation, charge pump circuit 12 generates a current which may be referred to as a pump current I_{PUMP}, that is comprised of a first portion and a second portion. The first portion flows towards current determination/comparator circuit 14 and may be referred to as an excessive portion I_{CLUMP} of pump current I_{PUMP} and the second portion flows towards load 22 and may be referred to as a load portion I_{LOAD} of pump current I_{PUMP}. Pump current I_{PUMP} also may be referred to as a supply current and is proportional to the capacity C_{CP} of charge pump circuit 12, the operating voltage V_{CC}, and the clock frequency f_{CLK} of charge pump circuit 12. More particularly, pump current bump is proportional to the product of the capacity C_{CP} of charge pump circuit 12, the operating voltage V_{CC}, and the clock frequency f_{CLK}. The clock frequency f_{CLK} of oscillator circuit 20 may be adjusted by adjusting the resistance of oscillator circuit 20.

It should be understood that portion I_{CLUMP} represents an excess current value of the entire system current that drains power from power sources such as, for example, batteries used in portable applications. Because current I_{CLUMP} represents a current that drains power sources, it may be referred to as a wasted current or as waste current. It should be noted that the current I_{CLUMP} flowing towards regulator circuit 24 may be represented by the following equation:

I_{CLUMP}=I_{PUMP}−I_{LOAD}.

Thus, current I_{CLUMP} represents a portion of the system current that decreases the charge level of power supply devices such as, for example, batteries or capacitors that provide power to the system.

In addition to determining the value of excess current I_{CLUMP}, current determination/current comparator circuit 14 compares excess current I_{CLUMP} with a reference current and generates logic values at outputs 14C and 14D of current determination/current comparator circuit 14 in accordance with the comparison result. In accordance with an embodiment, current determination/current comparator circuit 14 is configured such that a logic 1 or a logic high voltage level appears at output 14C in response to excess current I_{CLUMP} being greater than a first reference current and a logic 0 or logic low voltage level appears at output 14B in response to current I_{CLUMP} being less than the first reference current. Similarly, current determination/comparator circuit 14 is configured such that a logic 1 or a logic high voltage level appears at output 14D in response to excess current I_{CLUMP} being greater than a second reference current and a logic 0 or logic low voltage level appears at output 14D in response to excess current I_{CLUMP} being less than the second reference current. By way of example, the first reference level is 10 microamps and the second current level is 20 microamps.

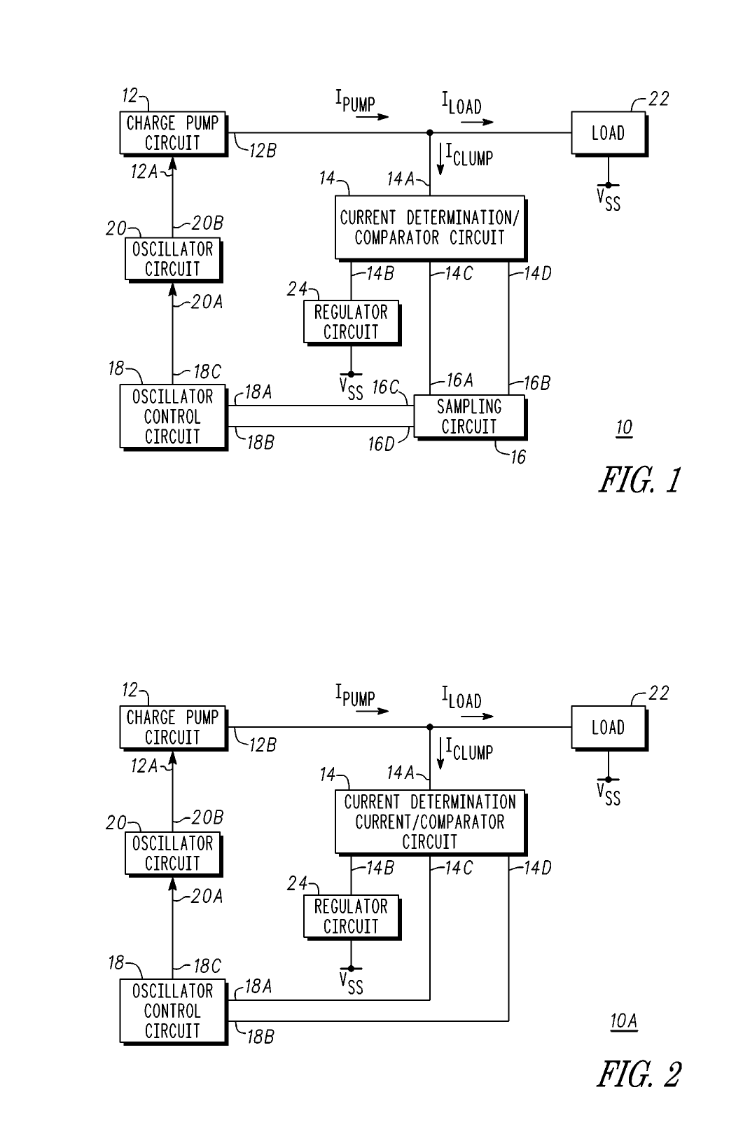

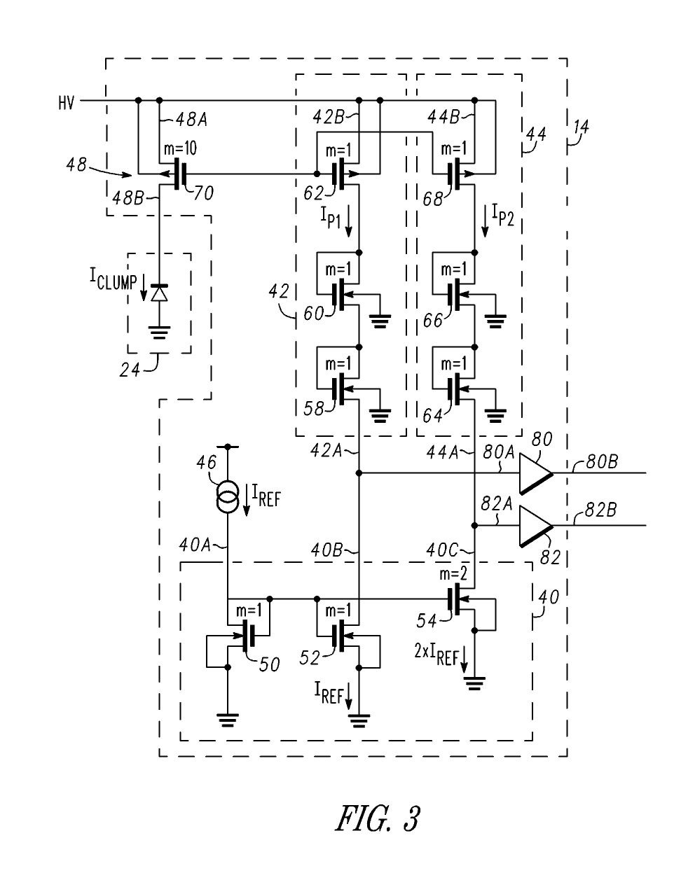

FIG. 2 is a circuit schematic of control circuit 10A in accordance with another embodiment of the present invention. Control circuit 10A differs from control circuit 10 in that sampling circuit 16 is absent from control circuit 10A. Accordingly, outputs 14C and 14D of current determination circuit/comparator circuit 14 are connected to inputs 18A and 18B of oscillator control circuit 18, respectively.

FIG. 3 is a circuit schematic of current determination/comparator circuit 14 in accordance with an embodiment of the present invention. Current determination/comparator circuit 14 includes a current minor 40, a voltage level shifting circuit 42, a voltage level shifting circuit 44, a current source 46, and a current source 48. Current minor 40 has an input 40A connected to current source 46, an input 40B connected to a terminal 42A of voltage level shifting circuit 42, and an input 40C connected to a terminal 44A of voltage level shifting circuit 44. Voltage level shifting circuit 42 has a terminal 42B connected to a terminal 44B of voltage level shifting circuit 44. Current source 48 has a terminal 48A connected to terminal 42B of voltage level shifting circuit 42 and to the terminal 44B of voltage level shifting circuit 44 and a terminal 48B connected to regulator circuit 24. It should be noted that voltage level shifting circuit 42 provides a first current path I_{P1} and voltage level shifting circuit 44 provides a second current path I_{P2}.

In accordance with an embodiment, current mirror 40 is comprised of transistors 50, 52, and 54, wherein each transistor 50, 52, and 54 has a control electrode and a pair of current carrying electrodes. By way of example, transistors 50, 52, and 54 are p-channel field effect transistors each having a gate, a source, and a drain. The source of transistor 50 serves as terminal 40A of current minor 40, the source of transistor 52 serves as terminal 40B of current minor 40, and the source of transistor 54 serves as terminal 40C of current minor 40. In accordance with an embodiment, transistor 54 is sized to have a width-to-length ratio that is twice the width-to-length ratio of transistor 50 and twice the width-to-length ratio of transistor 52. Thus, the current flowing into terminal 40C of current minor 40 is two times the current flowing into terminals 40A and 40B of current mirror 40. For example, a current I_{REF} flows from the source to the drain of transistor 50, a current I_{REF} flows from the source to the drain of transistor 52, and a current 2× I_{REF}, flows from the source to the drain of transistor 54. A current flowing from the source to the drain of a transistor may be referred to as a current flowing through the transistor. In accordance with an embodiment, the body of semiconductor material from which transistors 50, 52, and 54 are fabricated is coupled for receiving a source of operating potential V_{SS}. By way of example, operating potential V_{SS} is ground or a ground potential.

Voltage level shifting circuit 42 is comprised of a diode connected transistor 58, a diode connected transistor 60, and a transistor 62, and voltage level shifting circuit 44 is comprised of diode connected transistor 64, a diode connected transistor 66, and a transistor 68. In accordance with an embodiment, transistors 58, 60, 64, and 66 are p-channel transistors and transistors 62 and 68 are n-channel transistors, wherein each transistor has a control electrode and a pair of current carrying electrodes. As discussed above, the control electrodes may be gate electrodes and the current carrying electrodes may be a source electrode and a drain electrode. The gate electrodes may be referred to as gate terminals or gates, the source electrodes may be referred to as sources or source terminals, and the drain electrodes may be referred to as drains and drain terminals. By way of example, the source electrode of transistor 58 is connected to terminal 40B, the gate electrode of transistor 58 is connected to the drain electrode of transistor 58 and to source electrode of transistor 60. The gate electrode of transistor 60 is connected to the drain electrode of transistor 60 and to the drain electrode of transistor 62. The source electrode of transistor 64 is connected to terminal 40C, the gate electrode of transistor 64 is connected to the drain electrode of transistor 64 and to the source electrode of transistor 66. The gate electrode of transistor 66 is connected to the drain electrode of transistor 66 and to the drain electrode of transistor 68. The gate electrode of transistor 62 is connected to the gate electrode of transistor 68 and the source electrode of transistor 62 is connected to the source electrode of transistor 68, wherein the source electrode of transistor 62 serves as the second terminal of voltage level shifting circuit 42 and the source electrode of transistor 68 serves as the second terminal of voltage level shifting circuit 44. In accordance with an embodiment, the body of semiconductor material from which transistors 58, 60, 64, and 66 are fabricated is coupled for receiving a source of operating potential V_{SS}. By way of example, operating potential V_{SS} is ground or a ground potential, the body of semiconductor material from which transistors 62, 68, and 70 are fabricated is coupled for receiving a source of potential HV. The source of potential HV is received from output 12B of charge pump circuit 12.

Current source 48 may be comprised of a p-channel field effect transistor 70 having a gate electrode, a source electrode, and a drain electrode, wherein the gate electrode of transistor 70 is connected to the gate electrodes of transistors 62 and 68, the source electrode of transistor 70 is connected to the source electrodes of transistors 62 and 68, and the drain electrode of transistor 70 is connected to regulator circuit 24.

In accordance with an embodiment, transistors 62, 68, and 70 are sized, i.e., have a width-to-length ratio, such that transistor 70 is about ten times larger than transistors 62 and 68. Accordingly, the width-to-length ratio of transistor 70 is about ten times larger than the width-to-length ratios of each of transistors 62 and 68. In addition, the width-to-length ratios of each of transistors 50, 52, 58, 60, 64, and 66 are the same as or about the same as the width-to-length ratios of transistors 62 and 68, the width-to-length ratio of transistor 54 is about two times the width-to-length ratios of transistors 50, 52, 58, 60, 64, and 66, and the width-to-length ratio of transistor 70 is about five times the width-to-length ratio of transistor 54. Thus, the current flowing through transistor 70 is about ten times larger than the current flowing through transistor 62. For example, the current flowing through transistor 70 is I_{CLUMP}, the current I_{P1} flowing along the first current path substantially equals current I_{CLUMP} divided by 10 (I_{CLUMP}/10) and current I_{P2} flowing along the second current path substantially equals current I_{CLUMP} divided by 10 (I_{CLUMP}/10). It should be noted that currents flowing through terminals 40A, 40B, and 40C can be determined by adjusting the mirror ratios to make the current flowing through terminals 40A, 40B, and 40C much smaller than the current flowing through regulator circuit 24.

A driver 80 has in input 80A connected to terminal 40B and a driver 82 has an input 82A connected to terminal 40C. Driver 80 has an output 80B and driver 82 has an output 82B. In accordance with an embodiment, output 80A serves as output 14B of current determination/comparator circuit 14 and output 82A serves as output 14C of current determination/comparison circuit 14. Driver 80 may be referred to as a buffer, driver 82 may be referred to as a buffer, output 80B serves as output 14C, and output 82B serves as output 14D.

Current determination/comparator circuit 14 is configured to compare excess current I_{CLUMP} with reference current I_{REF} and with a current 2× I_{REF}. In accordance with an example and in response to current I_{CLUMP} being less than or equal to reference current I_{REF}, current determination/comparator circuit 14 generates signals at outputs 14C and 14D that causes oscillator control circuit 18 to generate a control signal to increase the frequency of the output signal of oscillator circuit 20; in response to current I_{CLUMP} being greater than or equal to reference current 2× I_{REF}, current determination/comparator circuit 14 generates signals at outputs 14C and 14D that causes oscillator control circuit 18 to generate a control signal to decrease the frequency of the output signal of oscillator circuit 20; and in response to current I_{CLUMP} being greater than reference current I_{REF} and less than reference current 2× I_{REF}, current determination/comparator circuit 14 generates signals at outputs 14C and 14D that cause oscillator control circuit 18 to remain at its nominal operating frequency. By way of example, reference current I_{REF} is approximately 10 μA and reference current 2× I_{REF} is approximately 20 μA.

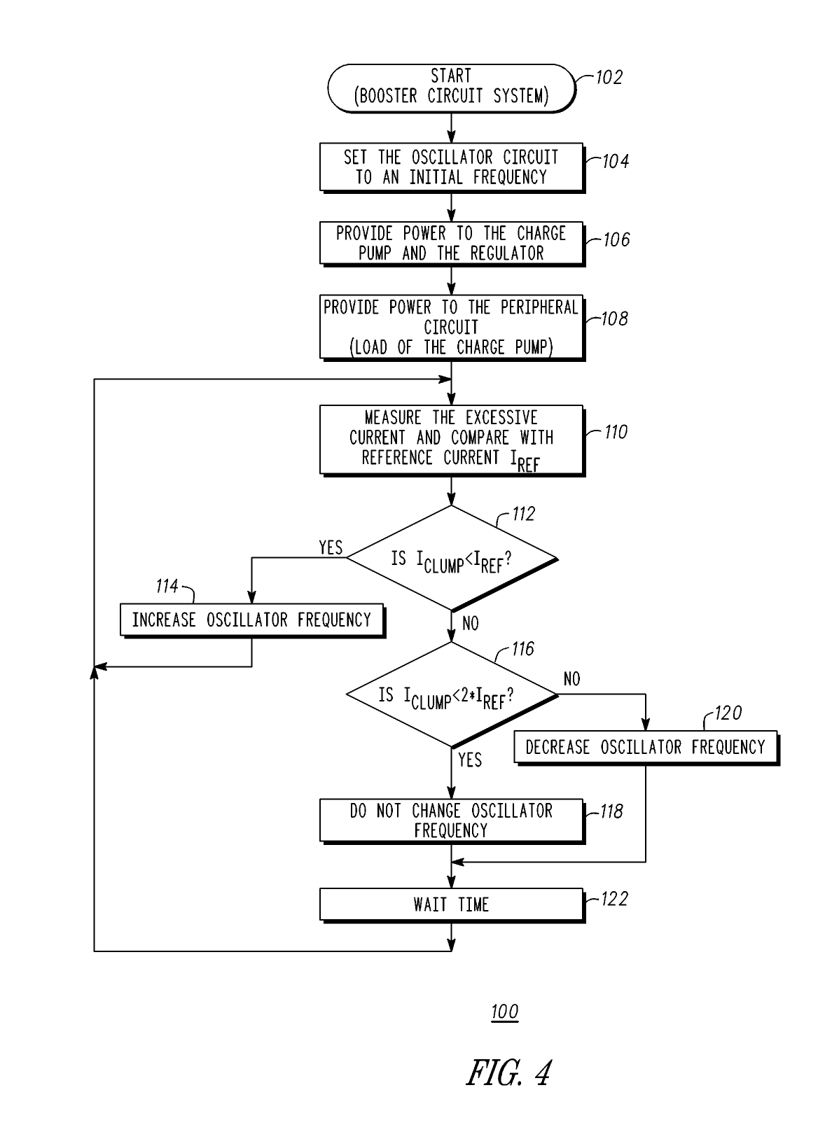

FIG. 4 is a flow chart 100 illustrating a method for controlling a charge pump such as, for example, charge pump 12 (shown in FIGS. 1 and 2) in accordance with an embodiment of the present invention. Oval 102 indicates a start of a method for controlling charge pump 12. Oscillator circuit 20 is set to an initial oscillator frequency (indicated by box 104). At a beginning step (indicated by box 106), power is supplied to the charge pump and a regulator circuit such as regulator 24. After a predetermined time, power is supplied to the peripheral circuitry (indicated by box 108). By way of example, the peripheral circuitry is the circuitry connected to the charge pump and may include current determination/comparator circuit 14, oscillator control circuit 18, and oscillator circuit 20. It should be noted that the predetermined time may be referred to as a ramp up time and may be 1 micro-second. Supplying power to the peripheral circuitry loads the charge pump, i.e., generates a charge pump current that flows from the charge pump.

Charge pump 12 generates charge pump current I_{PUMP}, that may be comprised of a load current portion (I_{LOAD}) and an excessive portion I_{CLUMP}. Load current portion I_{LOAD} flows toward load 22 and may be referred to as a load current and excessive portion I_{CLUMP} flows towards current determination/comparator circuit 14. Current determination/comparator circuit 14 determines the level or value of excessive portion I_{CLUMP} and compares the value of excessive portion I_{CLUMP} with are reference currents I_{REF} and 2× I_{REF} (indicated by box 110). It should be appreciated that excessive current I_{CLUMP} represents the excessive current value of the entire system. By way of example, reference current I_{REF} is 10 microamps (10 μA) and reference current 2× I_{REF} is 20 μA. In response to comparing excessive current I_{CLUMP} with reference current I_{REF} and excessive current I_{CLUMP} being less than reference current I_{REF} (indicated by the YES branch from decision diamond 112), oscillator control circuit 18 increases the frequency of oscillator circuit 20 (indicated by box 114). After a predetermined wait time, the process returns to the step at box 110 to continue with the oscillator frequency adjustment. By way of example, the predetermined wait time is one microsecond.

In response to excessive current I_{CLUMP} being greater than reference current I_{REF} (indicated by the NO branch from decision diamond 112), current determination/comparator circuit 14 compares excessive current I_{CLUMP} with reference current 2× I_{REF}. In response to excessive current I_{CLUMP} being less than reference current 2× I_{REF}, oscillator control circuit 18 leaves the frequency of oscillator circuit 20 unchanged (indicated by the YES branch from decision diamond 116). After a predetermined wait time, the process returns to the step at box 110 to continue with the oscillator frequency adjustment. By way of example, the predetermined wait time is one microsecond.

In response to excessive current I_{CLUMP} being greater than reference current 2× I_{REF} (indicated by the NO branch from decision diamond 116), oscillator control circuit 18 increases the frequency of oscillator circuit 20 (indicated by box 120). After a predetermined wait time (indicated by box 122), the process returns to the step at box 110 to continue with the oscillator frequency adjustment. By way of example, the predetermined wait time is one microsecond.

By now it should be appreciated that a control circuit suitable for use electronic systems that include regulator and a method for controlling the output voltage of the regulator have been provided. The control circuit and method balance power consumption and voltage stability to reduce current that is waster or excessive in regulator circuits. In accordance with embodiments, the control circuit adjusts the current supply from a charge pump circuit.

Although specific embodiments have been disclosed herein, it is not intended that the invention be limited to the disclosed embodiments. Those skilled in the art will recognize that modifications and variations can be made without departing from the spirit of the invention. It is intended that the invention encompass all such modifications and variations as fall within the scope of the appended claims.

What is claimed is:

1. A control circuit, comprising:
a charge pump circuit having an input and an output;
a current determination/comparator circuit having an input and a plurality of outputs, the input of the circuit coupled to the output of the charge pump; and
a regulator circuit having a first terminal and a second terminal, the first terminal of the regulator circuit coupled to a first output of the plurality of outputs of the current determination/comparator circuit.

2. The control circuit of claim 1, further including an oscillator circuit having an input and an output, the input of the oscillator circuit coupled to the input of the charge pump.

3. The control circuit of claim 2, further including an oscillator control circuit having a first input and an output, the output of the oscillator control circuit coupled to the input of the oscillator circuit.

4. The control circuit of claim 3, wherein the oscillator control circuit further includes a second input and the current determination/comparator circuit further includes a second output and a third output, wherein the second output of the current determination/comparator circuit is coupled to the first output of the oscillator control circuit and the third output of the current determination/comparator circuit is coupled to the second input of the oscillator control circuit.

5. The control circuit of claim 3, wherein the oscillator control circuit further includes a second input and the current determination/comparator circuit further includes a second output and a third output, and further including a sampling circuit having a first input, a second input, a first output, and a second output, wherein the second output of the current determination/comparator circuit is coupled to the first input of the sampling circuit, the third output of the current determination/comparator circuit is coupled to the second input of the sampling circuit, the first output of the sampling circuit is coupled to the first input of the oscillator control circuit and the second output of the sampling circuit is coupled to the second input of the oscillator control circuit.

6. The control circuit of claim 1, wherein the current determination/comparator circuit comprises:
a current mirror having a first terminal, a second terminal, and a third terminal;
a first current source coupled to the first terminal of the current minor;
a first voltage level shifting circuit having a first terminal and a second terminal, the first terminal of the first voltage level shifting circuit coupled to the second terminal of the current mirror;
a second voltage level shifting circuit having a first terminal and a second terminal, the first terminal of the second voltage level shifting circuit coupled to the third terminal of the current minor, the second terminal of the second voltage level shifting circuit coupled to the second terminal of the first voltage level shifting circuit; and
a second current source having a first terminal and a second terminal, the first terminal of the second current source coupled to the second terminal of the first voltage level shifting circuit and the second terminal of the second voltage level shifting circuit.

7. The control circuit of claim 6, wherein the current mirror comprises:
a first current source having a first terminal and a second terminal;
a first transistor having a control electrode, a first current carrying electrode, and a second current carrying electrode, wherein the control electrode of the first transistor is coupled to the first current carrying electrode of the first transistor and to the first terminal of the first current source, and the second current carrying electrode is coupled for receiving a first source of operating potential;
a second transistor having a control electrode, a first current carrying electrode, and a second current carrying electrode, wherein the control electrode of the second transistor is coupled to the control electrode of the first transistor, the first current carrying electrode of the second transistor serves as the second terminal of the current minor, and the second current carrying electrode is coupled for receiving the first source of operating potential; and
a third transistor having a control electrode, a first current carrying electrode, and a second current carrying electrode, wherein the control electrode of the third transistor is coupled to the control electrodes of the first transistor, the first current carrying electrode of the third transistor serves as the third terminal of the current minor, and the second transistor and the second current carrying electrode is coupled for receiving the first source of operating potential.

8. The control circuit of claim 8, wherein the first voltage level shifting circuit comprises:
a fourth transistor having a control electrode, a first current carrying electrode, and a second current carrying electrode, the control electrode of the fourth transistor coupled to the first current carrying electrode of the fourth transistor, and the second current carrying electrode of the fourth transistor coupled to the first current carrying electrode of the second transistor;
a fifth transistor having a control electrode, a first current carrying electrode, and a second current carrying electrode, the control electrode of the fifth transistor coupled to the first current carrying electrode of the fifth transistor and the second current carrying electrode of the fifth transistor coupled to the first current carrying electrode of the fourth transistor; and
a sixth transistor having a control electrode, a first current carrying electrode, and the second current carrying electrode, the second current carrying electrode of the sixth transistor coupled to the first current carrying electrode of the fifth transistor.

9. The control circuit of claim 8, wherein a second voltage level shifting circuit comprises:
a seventh transistor having a control electrode, a first current carrying electrode, and a second current carrying electrode, the control electrode of the seventh transistor coupled to the first current carrying electrode of the seventh transistor, and the second current carrying electrode of the seventh transistor coupled to the first current carrying electrode of the third transistor;
an eighth transistor having a control electrode, a first current carrying electrode, and a second current carrying electrode, the control electrode of the eighth transistor coupled to the first current carrying electrode of the seventh transistor and the second current carrying electrode of the eighth transistor coupled to the first current carrying electrode of the seventh transistor; and
a ninth transistor having a control electrode, a first current carrying electrode, and the second current carrying electrode, the control electrode of the ninth transistor coupled to the control electrode of the sixth transistor and the second current carrying electrode of the ninth transistor coupled to the first current carrying electrode of the eighth transistor.

10. The control circuit of claim 9, wherein the current determination/comparator circuit further includes a tenth transistor having a control electrode, a second current carrying electrode, and a third current carrying electrode, the control electrode of the tenth transistor coupled to the control electrode of the sixth transistor and to the control electrode of the ninth transistor, and the first current carrying electrode of the tenth transistor coupled to the first current carrying electrode of the sixth transistor and to the first current carrying electrode of the ninth transistor.

11. The control circuit of claim 10, further including a Zener diode having an anode and a cathode, the cathode of the Zener diode coupled to the second current carrying electrode of the tenth transistor and the anode of the Zener diode coupled for receiving the first source of operating potential.

12. A control circuit, comprising:
a multifunction current analysis circuit having an input and a first output and a second output, the input of the multifunction current analysis circuit configured to receive a first current;
an oscillator control circuit having a first input, a second input, and an output, the first input of the oscillator control circuit coupled to the first output of the multifunction current analysis circuit and the second input of the oscillator control circuit coupled to the second output of the multifunction current analysis circuit; and
a charge pump circuit having an input and an output, the input of the charge pump circuit coupled to the output of the oscillator control circuit.

13. The control circuit of claim 12, further including a regulator circuit having an input and an output, the input of the regulator circuit coupled to a third output of the multifunction current analysis circuit.

14. The control circuit of claim 12, further including a sampling circuit having a first input, a second input, a first output, and a second output, wherein the first input of the sampling circuit is coupled to the first output of the multifunction current analysis circuit, the second input of the sampling circuit is coupled to the second output of the multifunction current analysis circuit, the first output of the sampling circuit is coupled to the first input of the oscillator control circuit, and the second output of the sampling circuit is coupled to the second input of the oscillator control circuit.

15. The control circuit of claim 14, further including a regulator circuit having an input and an output, the input of the regulator circuit coupled to a third output of the multifunction current analysis circuit.

16. The control circuit of claim 12, wherein the multifunction current analysis circuit comprises:
a current mirror having a first terminal, a second terminal, and a third terminal;
a first current source coupled to the first terminal of the current minor;
a first voltage level shifting circuit having a first terminal and a second terminal, the first terminal of the first voltage level shifting circuit coupled to the second terminal of the current mirror;
a second voltage level shifting circuit having a first terminal and a second terminal, the first terminal of the second voltage level shifting circuit coupled to the third terminal of the current minor, the second terminal of the second voltage level shifting circuit coupled to the second terminal of the first voltage level shifting circuit; and
a second current source having a first terminal and a second terminal, the first terminal of the second current source coupled to the second terminal of the first voltage level shifting circuit and the second terminal of the second voltage level shifting circuit.

17. A method for controlling a voltage of a semiconductor component, comprising:
using a charge pump circuit to generate a charge pump current, wherein the charge pump current comprises at least a first portion and a second portion;
generating a first current having a first current level from the first portion of the charge pump current, a second current having a second current level from the first portion of the charge pump circuit, and a third current having a third current level from the first portion of the charge pump current, wherein the second current level and the third current level are less than the first current level;
comparing the second current level with the third current level to generate a first comparison result; and
using the first comparison result to control a frequency of an output signal of an oscillator circuit.

18. The method of claim 17, wherein generating the first current having the first current level from the first portion of the charge pump current, the second current having the second current level from the first portion of the charge pump circuit, and the third current having the third current level from the first portion of the charge pump current comprises:
generating the first current using a regulator circuit; and
generating the second current and the third current using a current minor, wherein the third current level is n times the second current level, and wherein n is an integer.

19. The method of claim 17, further including increasing a frequency of an oscillator output signal in response to the first current level of the first current being less than the second current level of the second current and increasing the frequency of the oscillator output signal in response to the first current level of the first current being greater than the third current level of the third current.

20. The method of claim 19, further including leaving frequency of the oscillator circuit unchanged in response to the first current level of the first current being greater than the second current level of the second current or less than the third current level of the third current.
